(19) United States
(12) Patent Application Publication
(10) Pub. No.: US 2010/0126167 A1
(43) Pub. Date: May 27, 2010

(54) ELECTROMECHANICAL BRAKE BOOSTER

(75) Inventors: Willi Nagel, Remseck/Hochdorf (DE); Dirk Hofmann, Krnov-Pod Cvilinem (CZ)

Correspondence Address: RONALD E. GREIGG;GREIGG & GREIGG P.L.L.C., 1423 POWHATAN STREET, UNIT ONE, ALEXANDRIA, VA, 22314, US

(73) Assignee: ROBERT BOSCH GMBH, Stuttgart (DE)

(21) Appl. No.: 12/596,108

(22) PCT Filed: Feb. 26, 2008
(86) PCT No.: PCT/EP2008/052283

§ 371 Date: Oct. 15, 2009

(30) Foreign Application Priority Data
Apr. 19, 2007 (DE) 10 2007 018 469.9

(51) Int. Cl. F15B 7/00; B60T 13/74

(52) U.S. Cl. 60/545

(57) ABSTRACT

The invention relates to an electromechanical brake booster for a master brake cylinder of a hydraulic vehicle braking system. The invention provides to configure the brake booster such that it preferably includes a switchable freewheel, which enables an actuation of the master brake cylinder without any movement of the electric motor of the brake booster. The invention further provides to configure the brake booster such that it includes a mechanical gear having a variable transmission ratio, which has a high path transmission at the beginning of an actuation of the master brake cylinder, and a force transmission that rises with increasing actuation. A variable gear ratio is possible using a rack and pinion gear, the toothed rack of which has a soothing with a pitch that changes across the length of the toothed rack. A further possibility of a mechanical gear having a variable ratio is a toggle lever mechanism.

### PRIOR ART

The invention relates to an electromechanical brake booster having the characteristics of the preamble to claim 1.

In motor vehicles at this time, underpressure brake boosters are usual, which utilize an underpressure in an intake tube of an internal combustion engine of the motor vehicle to generate an auxiliary force that boosts a muscle power exerted by a vehicle driver for actuating a brake system of the motor vehicle. The underpressure brake boosters are typically flanged to a master cylinder; that is, they are disposed between a brake pedal and the master cylinder, and they introduce their auxiliary force between the brake pedal and a piston of the master cylinder. When the term brake pedal is used hereinafter, it is to be understood also to encompass a hand brake lever or other actuating element for a hydraulic vehicle brake system.

In modern internal combustion engines, the problem sometimes occurs that they fail to furnish an adequate underpressure for an underpressure brake booster, or that connecting an underpressure brake booster is unwanted because of its influence on the intake performance, or in other words on the delivery of the combustion air. For that reason, electromechanical brake boosters have been proposed that use an electric motor to generate an auxiliary force for actuating a master cylinder of a hydraulic vehicle brake system. In principle, external force actuation is also possible; that is, the master cylinder is actuated solely with the force of the electromechanical brake booster and not partly with muscle power as well. The force generated by the brake booster and exerted on the piston of the master cylinder is in this case called an external force rather than an auxiliary force. This too is intended to be within the scope of the invention. Normally, external force braking is preferred in which a vehicle driver must exert some of the actuation force by muscle power, which gives him feedback about the intensity of the brake actuation.

German Published Patent Disclosure DE 103 27 553 A1 discloses an electromechanical brake booster for a master cylinder of a hydraulic vehicle brake system. The known brake booster has an electric motor, which is embodied as a hollow shaft motor and is disposed coaxially around a piston rod that connects a brake pedal with a piston of a master cylinder. A spindle drive is disposed in the hollow shaft motor and its nut is driven by a rotor of the electric motor, while its spindle is embodied as a hollow rod that likewise concentrically surrounds the piston rod. The spindle cooperates with a stop of the piston rod, by way of which stop it displaces the piston rod in the direction of an actuation of the master cylinder. If the known brake booster should fail, then the master cylinder can be actuated by muscle power using the brake pedal, without brake force boosting. In an accident, with the known brake booster the brake pedal can be pulled away in the direction of brake actuation in order to reduce the risk of injury to a vehicle driver. The accident can be detected with an acceleration sensor, which is present for instance for tripping vehicle air bags as well.

A further electromechanical brake booster is disclosed in U.S. Pat. No. 6,634,724 B2. This brake booster has a conventional electric motor, which via a step-down gear and a rack and pinion gear acts on the piston of a master cylinder or on a piston rod connecting the piston to a brake pedal. The electric motor is angularly offset by 90°, or more precisely is disposed at a tangent to the piston rod.

A further electromechanical brake booster is disclosed in German Published Patent Disclosure DE 101 13 346 A1. In this brake booster, torque from an electric motor is introduced into a pedal shaft of a brake pedal via a worm gear.

Explanation and Advantages of the Invention

The electromechanical brake booster of the invention having the characteristics of claim 1 has an electric motor and a rotation-to-translation conversion gear that converts a rotary driving motion of the electric motor into a linear motion for actuating a master cylinder of a hydraulic vehicle brake system. A spindle drive or a rack and pinion gear can for instance be instance be used as the rotation-to-translation conversion gear. A rotatable or pivotable cam that is pivoted by the electric motor and presses directly or indirectly against a piston of the master cylinder can also be considered for the rotation-to-translation conversion gear. Furthermore, a lever gear, for instance in the form of a crank drive, can be used as the rotation-to-translation conversion gear. The electric motor drives the crank to a pivoting motion, which is converted via a connecting rod into a translational motion for actuating the master cylinder.

The brake booster of the invention furthermore has a mechanical gear with a variable gear ratio. A variable gear ratio is for instance also possible with a rack and pinion gear (claim 2). For the sake of changing the gear ratio, a pitch of a toothing of the rack can vary over a length of the rack. Also by changing a spacing a gear wheel from the rack of a rack and pinion gear, or by using a non-circular gear wheel with a variable diameter, a change in the gear ratio is possible. A variable gear ratio is also possible with a coupling mechanism (claim 3), for instance a toggle mechanism. Coupling mechanisms are also called lever gears or kinematic chains. A gear with a variable gear ratio enables a major travel boost at the onset of actuation of the master cylinder, or in other words makes fast brake actuation and a major boost in force or torque possible at the end of the actuation, at high hydraulic pressure and with strong braking and actuation force.

As noted, by means of the variable gear ratio, a major force or torque boost is possible with a strong brake and actuation force. Correspondingly, a torque that the electric motor of the brake booster must exert to generate a predetermined maximum auxiliary force decreases. The invention thus makes a lower-power and hence smaller and lighter-weight electric motor with lower current consumption possible.

If a brake actuation by muscle power is effected via the gear with the variable gear ratio of the brake booster of the invention, then this additionally has the advantage that both the muscle power and the external force of the brake booster are boosted; with a strong actuation force, a major boost of the muscle power is attained via the gear with the variable gear ratio of the brake booster. The muscle power required to generate a strong braking force is reduced. Reducing the muscle power for actuating a brake with strong braking force is an advantage particularly if the brake booster fails, since for actuating the brake the brake booster has to be moved (driven), which requires some of the muscle power.

The dependent claims have advantageous features and refinements of the invention defined by claim 1 as their subject.

Claim 8 contemplates a worm gear for a brake booster, because it has a major step-down in rpm and a major step-up in torque. The worm gear is preferably provided as a first or only gear stage and is driven directly by the electric motor of the brake booster. Besides its high step-down or step-up ratio, a worm gear has the advantage that it reduces the rpm sharply, thus reducing the noise that is generated particularly as a result of high rotary speeds. A refinement of the invention in accordance with claim 9 contemplates a plastic wheel of the worm gear, which also serves to reduce noise.

According to claim 13, the brake booster of the invention has a free wheel mechanism, which can also be called a directionally shifted clutch. The free wheel mechanism transmits the motion of the electric motor in the actuation direction to the master cylinder. If a motion of the brake pedal is faster than the motion of the electric motor or of the brake booster, or if the electric motor does not move at all because of some defect, then the free wheel mechanism allows an actuation of the master cylinder with the brake pedal. The free wheel mechanism of the brake booster of the invention is used in its function as an overrunning clutch. Both form-locking free wheel mechanisms, such as ratchet free wheel mechanisms, and force-locking clamping free wheel mechanisms can be used. Besides rotating, or in other words or rotationally acting, free wheel mechanisms, linear free wheel mechanisms are also possible, which transmit a linear motion of the brake booster directly or indirectly to a piston of the master cylinder and allow a relative motion in the opposite direction, that is, the free wheel mechanism direction, so that once again, a motion of the piston of the master cylinder in the direction of actuating the hydraulic vehicle brake system is possible without motion of the brake booster, or with a slower motion of the brake booster. A linear free wheel mechanism may for instance have a ratchet that cooperates with a rack that has sawtooth toothing. Besides form-locking free wheel mechanisms, in the case of linear free wheel mechanisms force-locking free wheel mechanisms with clamping bodies are also possible.

Preferably, the free wheel mechanism of the brake booster of the invention is disposed such that upon an actuation of the master cylinder by muscle power if the brake booster is defective, as few parts as possible of the brake booster are also jointly moved, so that a motion resistance of the brake booster is low. Hence the free wheel mechanism is preferably disposed as close as possible to a final member of the brake booster, possibly even between the last member of the brake booster and a piston rod of the master cylinder; with the disposition, it is the action, that is, the introduction of the force of the brake booster, that is meant in particular, and not so much the locational disposition. However, a free wheel mechanism that is disposed directly on the electric motor of the brake booster is also possible within the scope of the invention.

The advantage of this feature of the invention is that an actuation of the master cylinder is possible if the brake booster fails, and only a few, or in any case not all, of the parts of the brake booster have to be jointly moved. There is low motion resistance of the non-moved brake booster to an actuation of the master cylinder. A further advantage of the invention is a comparatively simple, economical design and the possibility of using a conventional electric motor. In comparison with a hollow rotor motor, the lower moment of mass inertia is another advantage. In an accident, a retraction, that is, a motion of the brake pedal in the direction of a brake actuation, is possible with the brake booster of the invention, for reducing the risk of injury.

Claim 14 contemplates a shiftable free wheel mechanism, which in the engaged state acts a free wheel mechanism and in the disengaged state disconnects the electric motor of the brake booster, and preferably also its gear or parts of the gear, mechanically from the master cylinder. By disengaging the free wheel mechanism, a release of the master cylinder without a motion of the brake booster is possible; at the least, not all the parts of the brake booster have to be jointly moved. The force required for releasing the master cylinder is reduced as a result.

Further characteristics of the invention will become apparent from the ensuing description of embodiments of the invention in conjunction with the claims and the drawings. Individual characteristics can each be implemented on their own or in groups in embodiments of the invention. For instance, the free wheel mechanism does not necessarily require the mechanical gear with the variable gear ratio.

### BRIEF DESCRIPTION OF THE DRAWINGS

The invention is described below in terms of embodiments shown in the drawings. The drawings show four embodiments of electromechanical brake boosters according to the invention. The drawings must be understood to be schematic, simplified illustrations for the sake of comprehension and explanation of the invention.

### EMBODIMENTS OF THE INVENTION

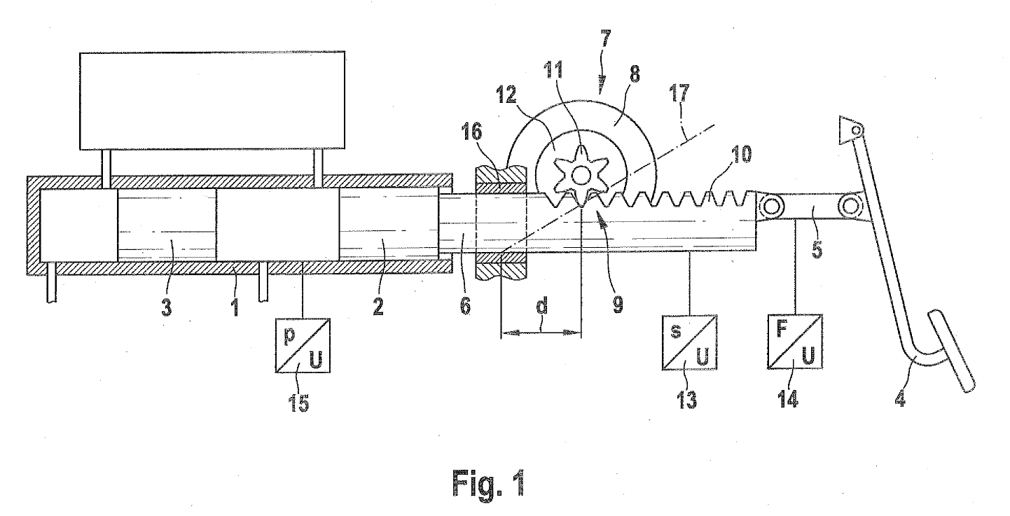

FIG. 1 schematically shows a master cylinder 1 of a hydraulic vehicle brake system, not otherwise shown, of a motor vehicle. A rod piston 2 and a floating piston 3 are received in the master cylinder 1. The rod piston 2 is moved mechanically with a brake pedal 4, via a tappet rod 5 and a piston rod 6. The tappet rod 5 connects the piston rod 6 in articulated fashion to the brake pedal 4. The floating piston 3 is subjected to and moved by a hydraulic pressure that the rod piston 2 generates upon its displacement into the master cylinder 1. If there is a leak, the floating piston 3 is moved by contact with the rod piston 2. This is known per se and requires no further explanation. The piston rod 6 is rigidly connected to the rod piston 2, and the piston rod 6 may be in one piece with the rod piston 2.

An electromechanical brake booster 7 in accordance with the invention is disposed between the brake pedal 4 and the master cylinder 1. The brake booster 7 has an electric motor 8 with a step-down gear flanged to it and a rack and pinion gear 9 with a rack 10 and a gear wheel 11 that meshes with the rack 10. The rack and pinion gear 9 fowls a rotation-to-translation conversion gear, which converts a rotary driving motion of the electric motor 8, or of the gear flanged to it, into a translational motion for displacing the rod piston 2. For introducing a force of the brake booster 7, the rack 10 can be connected in articulated fashion or rigidly to the rod piston 2 or its piston rod 6. In the embodiment shown of the invention, the piston rod 6 has the toothing of the rack 10; thus the piston rod 6 also forms the rack 10 of the rack and pinion gear 9.

Between the step-down gear of the electric motor 8 and the gear wheel 11 of the rack and pinion gear 9 is a free wheel mechanism 12, which transmits a rotary motion from the gear to the gear wheel 11 in one direction of rotation and allows a rotation of the gear wheel 11 relative to an output shaft of the gear in the reverse direction of rotation. The free wheel mechanism 12 is also called a directionally shifted clutch, and in the brake booster 7 it is used in its function as an overrunning clutch. The blocking direction, in which the free wheel mechanism 12 transmits a rotary motion from the gear of the electric motor 8 to the gear wheel 11 of the rack and pinion gear 9, is the direction with which the rod piston 2 is displaced into the master cylinder 1, or in other words in which the master cylinder 1 is actuated.

For actuating the master cylinder 1, the brake pedal 4 is depressed by a vehicle driver using muscle power and in this way, the rod piston 2 is displaced into the master cylinder 1 via the coupling rod 5, the rack 10, and the piston rod 6. Upon the actuation of the master cylinder 1, the electric motor 8 of the brake booster 7 of the invention is supplied with current, and via its gear, the free wheel mechanism 2 and the gear wheel 11, it drives the rack 10. This means that the electric motor 8 or the brake booster 7 exerts a force in the actuation direction on the rod piston 2 of the master cylinder 1. The force exerted by the brake booster 7 onto the rod piston 2 is called the auxiliary force. It acts on the rod piston 2 in addition to the actuation by muscle power by means of the brake pedal 4. The auxiliary force of the brake booster 7 and the muscle power exerted by means of the brake pedal 4 add up to an actuation force that acts on the rod piston 2. Conversely, this means that the muscle power required for generating a certain actuation force is reduced by the auxiliary force exerted by the brake booster 7. Controlling or regulating the auxiliary force of the brake booster 7 is effected for instance as a function of a displacement travel of the rod piston 2, which is measured for instance with a travel sensor 13 on the piston rod 6 or the rack 10, by means of a force sensor 14 and/or a pressure sensor 15, which measures the hydraulic pressure in the master cylinder 1. The control or regulation is effected as a linear or nonlinear function of the aforementioned measured variables, by means of an electronic controller or regulator, not shown.

By means of the free wheel mechanism 12, actuation of the master cylinder 1 with the brake pedal by muscle power is possible without boosting by the brake booster 7, for instance if the brake booster 7 is defective. Upon an actuation of the master cylinder 1 with the brake pedal 4 without the action of the brake booster 7, the rack 10 jointly moves the gear wheel 11 that meshes with it, and the free wheel mechanism 12 disconnects between the gear wheel 11 and the step-down gear flanged to the electric motor 8. As a result, the motion resistance of the brake booster 7 is negligibly slight.

The free wheel mechanism 12 is shiftable; in the engaged state, it has the described function of an overrunning clutch. In the disengaged state, in both directions of rotation, the free wheel mechanism 12 disconnects the gear wheel 11 from the gear of the electric motor 8. In this way, easy restoration of the rod piston 2 in the event of failure of the brake booster 7 is possible. In an accident, which can be ascertained with an acceleration sensor known per se and not shown, it is possible by supplying current to the electric motor 8 to move the brake pedal 4 in the actuation direction via the rack 10 and the coupling rod 5, in order to reduce the risk of injury to a vehicle driver.

The rack and pinion gear 9 is a mechanical gear. The toothing of the rack 10 has a pitch which varies over the length of the rack 10. The pitch of the toothing of the rack 10 is greater at an end of the rack 10 that is near the master cylinder 1 and the rod piston 2, and with increasing distance from the rod piston 2 and the master cylinder 1 it decreases. As a result, the rack and pinion gear 9 has a variable gear ratio. At the onset of a displacement of the rack 10 and of the rod piston 2, a travel boost of the rack and pinion gear 9 is great, and as a result, a fast motion of the rod piston 2 is attained. With increasing displacement, the travel boost of the rack and pinion gear 9 decreases, and to the same extent a force boost of the rack and pinion gear 9 increases. As a result, the auxiliary force exerted by the brake booster 7 becomes greater, at a constant torque of the electric motor 8, with increasing displacement of the rod piston 2, or in other words with increasing hydraulic pressure in the master cylinder 1 and an increasing actuation force.

In the embodiment of the invention shown in FIG. 1, the rack 10 is rigidly connected to the piston rod 6 and the rod piston 2. However, this is not compulsory for the invention. The rigid connection of the rack 10 and the rod piston 2 makes it possible to guide the rack 10 displaceably with a single guide 16. In the embodiment shown, the guide 16 is disposed in the region of the piston rod 6, which is connected rigidly to the rack 10 and in particular is in one piece with it. The guide 16 of the rack 10 is disposed offset from the gear wheel 11 of the rack and pinion gear 9 by an offset d in the direction of the master cylinder 1. The offset d is selected such that an imaginary line of application 17 of the rack and pinion gear 9 intersects the guide 16 on a side diametrically opposite the toothing of the rack 10. The line of application 17 is an imaginary straight line through a point of contact or a line of contact on the flanks of the teeth of the gear wheel 11 and of the rack 10, which touch one another upon actuation of the master cylinder 1. The line of application 17 is a normal to the tooth flanks at the point of contact or line of contact. The Line of application 17 indicates the direction in which the meshing tooth at that time of the gear wheel 11 exerts a force on the corresponding tooth of the rack 10. Thus the line of application 17 indicates the direction of the force, exerted by the gear wheel 11 on the rack 10, upon actuation of the master cylinder 1. Because of the offset d by which the guide 16 of the rack 10 is intersected by the line of application 17 on a side diametrically opposite the toothing of the rack 10, the guide 16 braces the rack 10 without torque. A single guide 16 is sufficient for the rack 10, and a torque or a transverse force on the rod piston 2, which would cause increased wear, is avoided. Moreover, the offset d of the guide 16, which because of the offset d braces the rack 10 without torque, makes it possible to embody the guide 16 as shown with a ring bearing as a slide bearing for the rack 10 or the piston rod 6. A slide bearing, especially in the structural form of a ring bearing, is inexpensive and makes easy assembly possible. An additional advantage is that a ring bearing as a guide 16 braces the rack 10 against a transverse force that occurs if the rack and pinion gear 9 has a helical toothing.

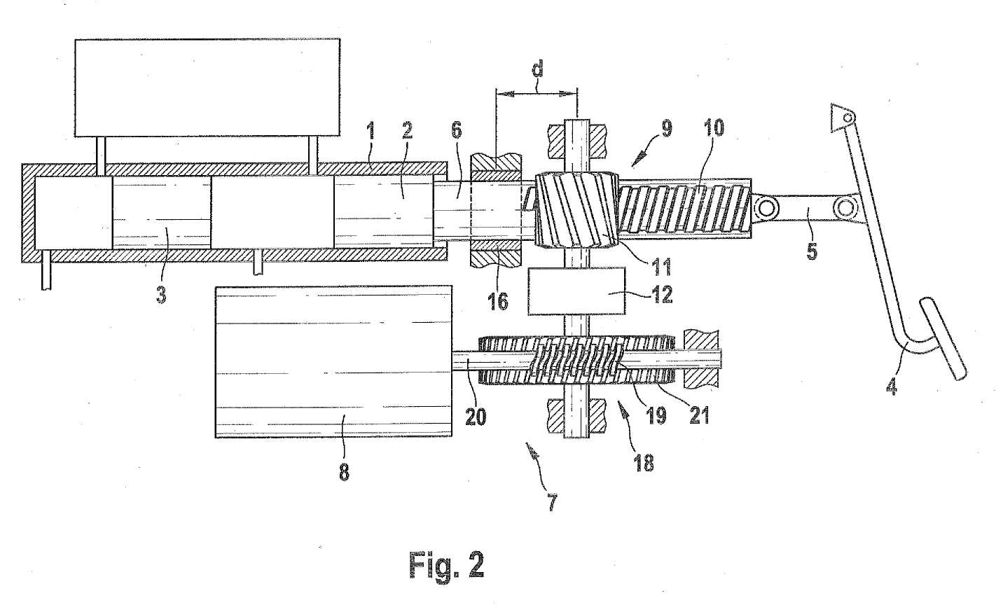

In the ensuing description of FIGS. 2 through 4, the same reference numerals are used for components that match FIG. 1. In agreement with FIG. 1, the electromechanical brake booster 7 of the invention in FIG. 2 has a rack and pinion gear 9, with a rack 10 with which a gear wheel 11 meshes. The rack and pinion gear 9 has a helical toothing. The rack 10 is rigidly connected to the piston rod 6 of the rod piston 2. The brake pedal 4 is also present, which is connected in articulated fashion to the rack 10 and the piston rod 6 via the coupling rod 5. The free wheel mechanism 12 and the electric motor 8 that drives the rack and pinion gear 9 via the free wheel mechanism 12 are also present. In a distinction from FIG. 1, the electric motor 8 drives the free wheel mechanism 12 via an angular gear 18. In the exemplary embodiment, the angular gear 18 is a worm gear, with a worm 19 that is disposed on the shaft 20 of the electric motor 8 in a manner fixed against relative rotation and meshes with a worm wheel 21. The worm wheel 21 is disposed on an input shaft of the free wheel mechanism 12 in a manner fixed against relative rotation and drives the free wheel mechanism. The win in wheel 21 is of plastic, for the sake of quiet gear operation. As an angular gear 18, the worm gear has a high step-down ratio, making an additional step-down gear unnecessary. However, the invention is not limited to a worm gear as the angular gear 18. The rack and pinion gear 9 also forms an angular gear, and both gears 9, 18 have a deflection of 90° each. Overall, the electric motor 8 is deflected relative to the rack 10 and thus to the master cylinder 1 by 180° by means of the two angular gears 9, 18; that is, the electric motor 8 is disposed parallel to the master cylinder 1 and beside it. This makes a compact embodiment of the brake booster 7 of the invention with the master cylinder possible.

For the description of FIGS. 2-4, the description of FIG. 1 is additionally referred to, to avoid repetition.

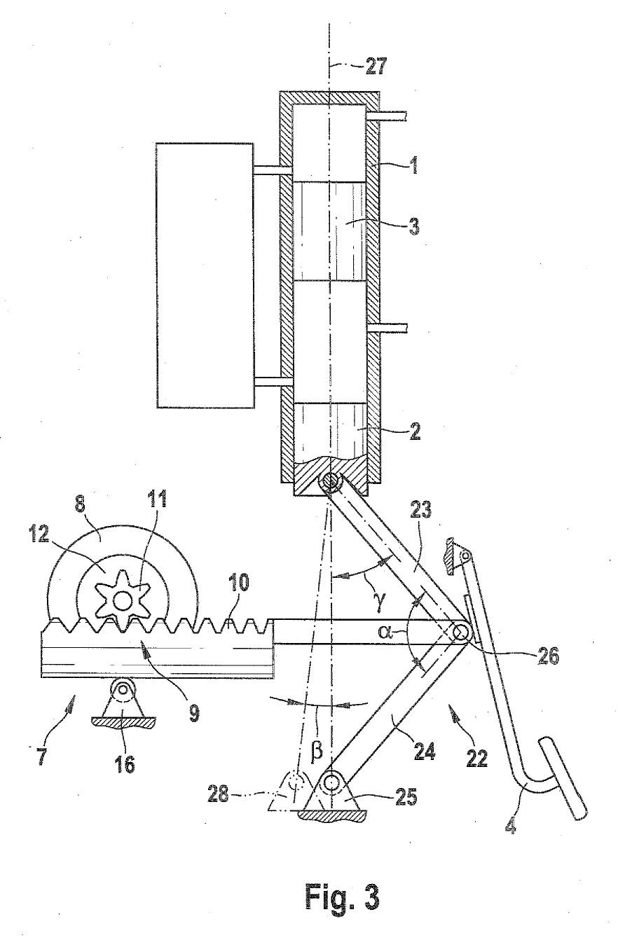

In FIG. 3, the electromechanical brake booster 7 of the invention acts on the rod piston 2 of the master cylinder 1 via a coupling mechanism 22. In the embodiment selected, the coupling mechanism 22, which can also be conceived of as a kinematic chain, is a toggle mechanism, or in other words a flat lever mechanism. The coupling mechanism 22 has a piston rod 23, one end of which is connected in articulated fashion to the rod piston 2 of the master cylinder 1. The other end of the piston rod 23 is connected in articulated fashion to a support lever 24, which is braced in articulated fashion on an abutment 27 that is stationary relative to the master cylinder 1. The joint connecting the piston rod 23 to the support lever 24 will hereinafter be called a knee joint. It is engaged on the one hand by the brake pedal 4, although with a sliding fit, to allow a longitudinal motion of the knee joint 26 on the brake pedal 4. The knee joint 26 is also engaged in articulated fashion by the rack 10 of the electromechanical brake booster 7. In principle, the rack 10 may also engage the knee joint 26 of the coupling mechanism 22 with pressure, instead of with tension as shown.

The brake booster 7 of FIG. 3 is constructed like the brake booster 7 of FIG. 1, so that the description above of it may be referred to. The brake booster 7 of FIG. 3 has an electric motor 8 with a step-down gear flanged to it, and the electric motor, via a shiftable free wheel mechanism 12, drives a gear wheel 11 that meshes with the rack 10. The gear wheel 11 and the rack 10 form a rack and pinion gear 9. Only the introduction of the auxiliary force generated by the brake booster 7 into the actuation of the rod piston 2 of the master cylinder 1 is done differently in FIG. 3 from FIG. 1, namely in articulated fashion, via the coupling mechanism 22 embodied as a toggle mechanism, instead of rigidly as in FIG. 1 with the rack 10 of the rack and pinion gear 9 onto the piston rod 6 of the rod piston 2. Also in FIG. 3, the piston rod 23 is connected in articulated fashion with the rod piston 2, while in FIG. 1, both the piston rod 6 and the rack 10 are connected rigidly to the rod piston 2.

In FIG. 3, the guide 16 of the rack 10 has a roller bearing, and it is disposed without offset relative to the gear wheel 11 of the rack and pinion gear 9. The guide 16 makes pivoting of the rack 10 possible.

For actuating the master cylinder 1 in FIG. 3, the brake pedal 4 is depressed, which displaceably engages the knee joint 26. Depressing the brake pedal 4 puts the coupling mechanism 22, embodied as a toggle mechanism, out of the angled position shown into a straighter position; that is, a knee angle α between the piston rod 23 and the support lever 24 increases. As a result, the coupling mechanism 22 pushes the rod piston 2 into the master cylinder 1, which is thus actuated.

The actuation is reinforced by the brake booster 7, which in the manner already described in conjunction with FIG. 1 exerts an auxiliary force that it introduces via the rack 10 at the knee joint 26. The auxiliary force acts in the direction of a greater straightening of the coupling mechanism 22 embodied as a toggle mechanism, or in other words in the direction of an actuation of the master cylinder 1. Controlling or regulating the auxiliary force of the brake booster is effected as described in conjunction with FIG. 1.

The coupling mechanism 22 embodied as a toggle mechanism is a mechanical gear with a variable gear ratio: The small knee angle α, at the onset of an actuation of the master cylinder 1, between the piston rod 23 and the support lever 24 causes a long displacement travel of the rod piston 2, given a predetermined travel of the knee joint 26. At the onset of actuation of the master cylinder 1, the rod piston 2 is thus moved quickly. With increasing straightening of the coupling mechanism 22 embodied as a toggle mechanism, or in other words with the knee angle α increasing, the travel boosting becomes less and force boosting becomes greater. With a straightened toggle mechanism, or in other words upon approach to a knee angle α of 180° between the piston rod 23 and the support lever 24, the force exerted by the toggle mechanism on the rod piston 2 tends toward infinity.

The boosting of the coupling mechanism 22 is determined not only by its geometry and position but also by the location of the abutment 25. In the embodiment shown in FIG. 3, a joint of the abutment 25 is located on an imaginary cylinder axis 27 of the master cylinder 1. As indicated by lines with dashes and double dots and by reference numeral 28, the abutment 25 of the coupling mechanism 22 can also be offset from the cylinder axis 27 of the master cylinder by an angle β. In addition to having an influence on the boosting of the coupling mechanism 22, the angular offset β of the abutment 25, 28 also has an influence on a transverse force exerted by the coupling mechanism 22 on the rod piston 2. The transverse force is created because the piston rod 23 engages the rod piston 2 not axially but rather at an attack angle γ to the cylinder axis 27. As a result of the angular offset β of the abutment 25, the attack angle γ of the piston rod 23 varies; the attack angle γ can decrease, causing the transverse on the rod piston 2 to decrease. In this connection, it should be taken into account that upon actuation of the master cylinder 1, the coupling mechanism 22 embodied as a toggle mechanism is increasingly straightened, and thus the attack angle γ by which the piston rod 23 meets the rod piston 2 is reduced. This reduces an increase in the transverse force, exerted by the piston rod 23 on the rod piston 2, while the actuation force is increasing.

The boosting of the coupling mechanism 22 can also be varied by draining brake fluid from the master cylinder 1. As a result, the rod piston 2 and the floating piston 3 are displaced into the master cylinder 1; that is, at a certain hydraulic pressure in the master cylinder 1, the pistons 2, 3 are displaced farther into the master cylinder 1 than without the reduction of the brake fluid volume in the master cylinder 1 by draining off brake fluid. As a result, the coupling mechanism 22 is more markedly straightened, and its force boosting is greater. In a vehicle brake system that has traction control (ABS, TCS, VDC, ESP), draining off brake fluid from the master cylinder 1 is effected by opening valves of the vehicle brake system, not shown. The brake fluid flows out of the master cylinder 1 into hydraulic reservoirs. With hydraulic pumps, which vehicle brake systems of this kind have, it is conversely also possible to pump brake fluid into the master cylinder 1 and thereby to lessen the straightening of the coupling mechanism 22.

This possibility of a hydraulic variation of the gear ratio of the mechanical coupling mechanism 22 by draining brake fluid from the master cylinder 1 is equally possible in the embodiment of the invention shown in FIG. 1. By draining brake fluid from the master cylinder 1, the pistons 2, 3 there as well are displaced farther into the master cylinder 1. The gear wheel 11 of the rack and pinion gear 9 as a result meshes at a different point of the rack 10, whose pitch varies over its length. As a result, the gear wheel 11 meshes at a point of the rack 10 at which the pitch of its toothing is less and the force boost is therefore greater.

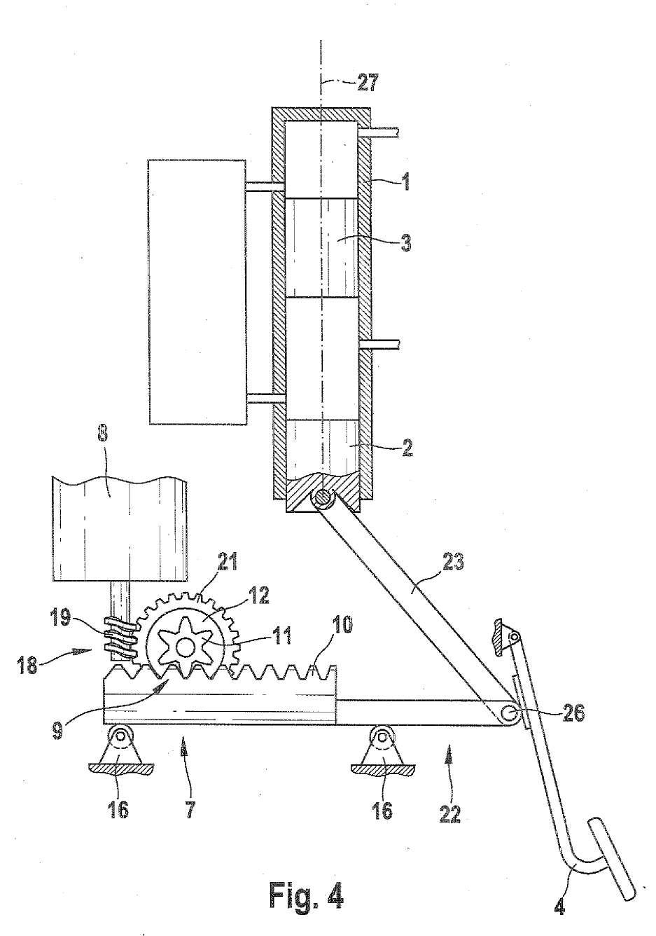

In comparison to FIG. 3, the embodiment of the invention shown in FIG. 4 has a “half toggle mechanism” as its coupling mechanism 22. In comparison to FIG. 3, the support lever 24 and its abutment 25 are absent. In FIG. 4 as in FIG. 3, the piston rod 23 is connected in articulated fashion to the rod piston 2. The other end of the piston rod 23 is connected in articulated fashion to the rack 10 of the brake booster 7. The joint connecting the piston rod 23 to the rack 10, as in FIG. 3, is also called a knee joint 26 in FIG. 4. In FIG. 4 as in FIG. 3, the brake pedal 4 engages the knee joint 26 displaceably.

In the embodiment of FIG. 4, the rack 10 is disposed transversely to the master cylinder 1 and is guided displaceably with two guides 16. The guides 16 are offset in both directions longitudinally to the rack 10 relative to the gear wheel 11 of the rack and pinion gear 9. The guides 16 brace the rack 10 in the axial direction relative to the master cylinder 1. By a displacement of the rack 10 with the brake pedal 4 and/or with the brake booster 7, the piston rod 23 is pivoted in the direction of the cylinder axis 27 of the master cylinder 1 and in the process displaces the rod piston 2. The coupling mechanism 22 of FIG. 4, which is a mechanical gear, has a variable gear ratio, of the kind that has been described in conjunction with the coupling mechanism 22 of FIG. 3. In this respect, see the discussion of FIG. 3.

As in FIG. 2, in FIG. 4 the electric motor 8 of the brake booster 7 drives the free wheel mechanism 12 via a worm gear, that is, an angular gear 18, and via the free wheel mechanism, it drives the gear wheel 11 of the rack and pinion gear 9. The angular gear 18 embodied as a worm gear has a worm 19 and a worm wheel 21, which for reasons of noise and expense made from plastic. As a result of the deflection by 90° each with the rack and pinion gear 9 and the worm gear 18, the electric motor 8 is disposed parallel to and beside the master cylinder 1. This makes a compact, space-saving disposition of the electromechanical brake booster 7 on the master cylinder 1 possible.

1-14. (canceled)

15. An electromechanical brake booster, having an electric motor and having a rotation-to-translation conversion gear, which converts a rotary driving motion of the electric motor into a linear motion for actuating a master cylinder, wherein the brake booster has a mechanical gear with a variable gear ratio.

16. The electromechanical brake booster as defined by claim 15, wherein the brake booster has a rack and pinion gear with a variable gear ratio.

17. The electromechanical brake booster as defined by claim 15, wherein the brake booster has a coupling mechanism as the gear with the variable gear ratio.

18. The electromechanical brake booster as defined by claim 16, wherein a rack of the rack and pinion gear is connected rigidly to a rod piston of the master cylinder.

19. The electromechanical brake booster as defined by claim 15, wherein the brake booster has a rack and pinion gear, the rack and pinion gear has a guide for a rack of the rack and pinion gear, and that the guide is disposed with an offset, relative to a gear wheel of the rack and pinion gear in the longitudinal direction of the rack, between the gear wheel and the master cylinder.

20. The electromechanical brake booster as defined by claim 19, wherein the guide of the rack of the rack and pinion gear is disposed in the region of line of application of the rack and pinion gear.

21. The electromechanical brake booster as defined by claim 20, wherein the guide has a ring bearing as a slide bearing for the rack of the rack and pinion gear.

22. The electromechanical brake booster as defined by claim 15, wherein the brake booster has a worm gear.

23. The electromechanical brake booster as defined by claim 22, wherein the worm gear has a plastic worm wheel.

24. The electromechanical brake booster as defined by claim 15, wherein the electric motor is disposed approximately parallel to and beside the master cylinder.

25. The electromechanical brake booster as defined by claim 24, wherein the brake booster has two angular gears.

26. The electromechanical brake booster as defined by claim 15, wherein a brake fluid volume in the master cylinder is reducible.

27. The electromechanical brake booster as defined by claim 15, wherein the brake booster has a free wheel mechanism, which enables an actuation of the master cylinder without motion of the electric motor.

28. The electromechanical brake booster as defined by claim 27, wherein the brake booster has a shiftable free wheel mechanism, which in an engaged state acts as a free wheel mechanism and in a disengaged state disconnects the electric motor mechanically from the master cylinder.

29. An electromechanical brake booster, having an electric motor and having a rotation-to-translation conversion mechanism, which converts a rotary driving motion of the electric motor into a linear motion for actuating a master cylinder, wherein the rotation-to-translation conversion mechanism has two angular gears.

30. The electromechanical brake booster as defined by claim 29, wherein one of the angular gears is a rack and pinion gear, and one of the angular gears is a worm gear.

31. The electromechanical brake booster as defined by claim 29, wherein one of the angular gears has a variable gear ratio.
